(19) United States
(12) Patent Application Publication
(10) Pub. No.: US 2017/0198751 A1
(43) Pub. Date: Jul. 13, 2017

(54) BEARING CAGE OR BEARING CAGE SEGMENT

(71) Applicant: Aktiebolaget SKF, Goteborg (SE)

(72) Inventors: Robert Gruell, Sulzdorf (DE); Loemba Anselme, Niederwerrn (DE)

(21) Appl. No.: 15/315,406

(22) PCT Filed: Jun. 18, 2015
(86) PCT No.: PCT/EP2015/063695

§ 371 Date: Dec. 1, 2016

(30) Foreign Application Priority Data
Jun. 24, 2014 (DE) 10 2014 212 072.1

(51) Int. Cl. F16C 33/44; B29C 45/00; F16C 33/38; F16C 33/46; F16C 33/56; B23P 15/00

(52) U.S. Cl. CPC F16C 33/44; F16C 33/56; B23P 15/003; F16C 33/3837; F16C 33/4617; B29C 45/0005; F16C 2208/36; F16C 2208/04; B29K 2071/00

(57) ABSTRACT

A bearing cage or bearing cage segment is disclosed, in particular for a rolling-element bearing, wherein the bearing cage includes a polyetheretherketone (PEEK) base material having a low and medium viscosity, and less than 30%, in particular 15% to 25%, reinforcing material is added to the base material, and the reinforced PEEK material has a shrinkage in the melt-flow direction that falls in the range of 0.4% to 0.6%.

The present invention relates to a bearing cage or a bearing cage segment, in particular for a rolling-element bearing, wherein the bearing cage includes a polyetheretherketone (PEEK) base material having a low or medium viscosity.

Bearing cages, or bearing cage segments assemblable as a bearing cage, for rolling-element bearings have the task to guide rolling elements and to hold them at a certain spacing. A balanced dynamic behavior of the bearing can thereby be ensured. Various materials are usually used for bearing cages, such as, for example, steel or brass or also plastic, in particular polymers, such as, for example, polyamide or polyetheretherketone (PEEK).

Here, a cage made from PEEK has the advantage that PEEK is more temperature- or chemical-resistant than other plastic materials. Furthermore, PEEK has a greater aging stability in continuous operation, since the tribological properties, i.e., the properties that are responsible for friction and wear, and also the mechanical stability are of higher quality in PEEK materials than in other plastics.

However, it is problematic with PEEK materials that the dimensional stability varies, in particular in large injection-molded PEEK cages. This means that the cages manufactured with PEEK cannot be reliably manufactured in the required sizes and dimensions. This is decisive in particular with large cage dimensions, with the result that high rejection rates and thus high costs arise.

An object of the present invention is therefore to provide a bearing cage or a bearing cage segment made from a PEEK base material, the dimensional-stability properties of which are significantly improved.

This object is achieved by a bearing cage or bearing cage segment for a rolling-element bearing according to patent claim 1.

According to the invention a bearing cage or a bearing cage segment for a rolling-element bearing is provided wherein the bearing cage or the bearing cage segment includes a polyetheretherketone (PEEK) base material having a low or medium viscosity. This viscosity advantageously makes possible a particularly good flow behavior during an injection-molding process for manufacturing the bearing cage or the bearing cage segment. Here the invention is based on the idea of adding less than 30%, in particular 15% to 25%, reinforcing material to the base material and thus obtaining a reinforced PEEK material that has a shrinkage in the melt-flow direction that falls in the range of 0.4% to 0.6%. Because of this shrinkage set in the range from 0.4% to 0.6% it has been surprisingly shown that the dimensional stability of the PEEK material can be maintained particularly well. Thus even large bearings can be produced, with negligible rejections, from a PEEK material. The reinforcing materials added thereto make possible in particular that the bearing cage or the bearing cage segment has particularly good mechanical properties, in particular with respect to its weld line strength and/or impact toughness.

According to a further advantageous exemplary embodiment a bearing cage or bearing cage segment is provided wherein the shrinkage of the PEEK material falls between 0.45% and 0.52%. It has advantageously been shown that with a shrinkage in this range the dimensional stability of the manufactured cages could be further improved.

According to a further advantageous exemplary embodiment, glass fibers and/or carbon fibers and/or graphite and/or Teflon are added as reinforcing materials to the PEEK base material, wherein according to the invention less than 30% of reinforcing materials are used. These reinforcing materials influence in particular the mechanical properties with the result that bearing cages or bearing cage segments can be provided with particularly good properties with regard to friction, wear, and mechanical strength.

Here, it is advantageous in particular if the reinforced PEEK material comprises approximately 20% glass fibers. A PEEK material can thereby be manufactured whose shrinkage falls in the range from 0.45% to 0.52%, whereby a particularly dimensionally stable bearing cage or a particularly dimensionally stable bearing cage segment can be manufactured. In addition, a PEEK material with the inventive composition and the inventive properties can be processed particularly well in the injection-molding process with the result that the bearing cages or bearing cage segments can be manufactured quickly and reliably.

Alternatively or additionally the reinforced PEEK material can also include less than 30% carbon fibers. Thus a PEEK material can also be provided that firstly ensures a particularly good bearing cage with regard to bearing stresses, but also provides a reliable dimensional stability.

According to a further advantageous exemplary embodiment the bearing cage or the bearing cage segment is manufactured using a casting method, injection-molding method, or injection method. Elaborate design shapes can thereby also be cost-effectively and quickly manufactured. It is particularly advantageous here if a PEEK material having a low viscosity or a medium viscosity is used as the PEEK base material, since it has proven that these materials have particularly good injection-molding properties.

Further advantages and advantageous embodiments are described in the dependent claims and the description.

Overall it has been advantageously shown that with a reinforced PEEK material having a contraction or shrinkage in the melt-flow direction in the range of 0.4% to 0.6%, bearing cages or bearing cage segments can be manufactured by injection molding that have particularly good dimensional stability. It is advantageous here in particular if less than 30% reinforcing materials or of a reinforcing material is added to the base material. A reinforced PEEK material having a shrinkage in the above-mentioned range can thereby be provided. However, the shrinkage optimally falls between 0.45% and 0.52% since this shrinkage range leads to a particularly stable dimensional stability in the bearing cage production. For the optimized properties of the bearing cages or bearing cage segments with regard to tribology, processability, dimensional stability, flow properties, mechanical properties, and surface properties it has also been shown that the use of approximately 20% glass fibers is particularly advantageous.

1. A bearing cage or bearing cage segment for a rolling-element bearing, comprising:
a polyetheretherketone (PEEK) base material having a low or medium viscosity, and
less than 30% reinforcing material added to the base material,
wherein the reinforced PEEK material has a shrinkage in the melt-flow direction that falls in the range of 0.4% to 0.6%.

2. The bearing cage or bearing cage segment according to claim 1, wherein the shrinkage falls between 0.45% and 0.52%.

3. The bearing cage or bearing cage segment according to claim 1, wherein the reinforcing material comprises glass fibers and/or carbon fibers and/or graphite and/or polytetrafluoroethylene.

4. The bearing cage or bearing cage segment according to claim 3, wherein the reinforced PEEK material includes approximately 20% glass fibers.

5. The bearing cage or bearing cage segment according to claim 3, wherein the reinforced PEEK material includes less than 30% carbon fibers.

6. The bearing cage or bearing cage segment according to claim 5, wherein the bearing cage or the bearing cage segment is manufactured using a casting method, injection-molding method, or injection method.

7. The bearing cage or bearing cage segment according to claim 1, wherein the reinforcing material is 15-25% of the PEEK base material.

8. The bearing cage or bearing cage segment according to claim 2, wherein the reinforcing material is 15-25% of the PEEK base material.

9. The bearing cage or bearing cage segment according to claim 8, wherein the reinforcing material is glass fibers.

10. The bearing cage or bearing cage segment according to claim 9, wherein the shrinkage falls between 0.45% and 0.52%.

11. The bearing cage or bearing cage segment according to claim 8, wherein the reinforcing material is carbon fibers.

12. The bearing cage or bearing cage segment according to claim 11, wherein the shrinkage falls between 0.45% and 0.52%.

13. A method for manufacturing a bearing cage or bearing cage segment, comprising:
preparing a material by adding less than 30% reinforcing material to a polyetheretherketone (PEEK) base material having a low or medium viscosity, wherein the resulting reinforced PEEK material has a shrinkage in the melt-flow direction that falls in the range of 0.4% to 0.6%, and
one of casting, injection-molding or injecting the reinforced PEEK material into the shape of a bearing cage or a bearing cage segment.

14. The method according to claim 13, wherein the reinforcing material is 15-25% of the PEEK base material.

15. The method according to claim 14, wherein the shrinkage falls between 0.45% and 0.52%.

16. The method according to claim 15, wherein the reinforcing material is glass fibers.

17. The method according to claim 15, wherein the reinforcing material is carbon fibers.
